(19) United States
(12) Patent Application Publication
(10) Pub. No.: US 2025/0313023 A1
(43) Pub. Date: Oct. 9, 2025

(54) IMAGE FORMING APPARATUS

(71) Applicant: CANON KABUSHIKI KAISHA, Tokyo (JP)

(72) Inventor: SHIMPEI KAKIZAKI, Chiba (JP)

(21) Appl. No.: 19/092,266

(22) Filed: Mar. 27, 2025

(30) Foreign Application Priority Data
Apr. 5, 2024 (JP) 2024-061632

(51) Int. Cl. B41J 29/13; B41J 11/00; B41J 29/377

(52) U.S. Cl. CPC B41J 29/13; B41J 11/002; B41J 11/006; B41J 29/377

(57) ABSTRACT

An image forming apparatus includes an open-close portion including a first surface configured to form part of an exterior and a second surface opposite to the first surface, an opening portion of the open-close portion being provided with at least one through hole penetrating from the first surface to the second surface, a first reinforcement member disposed on the second surface, and a second reinforcement member disposed on the second surface. The first reinforcement member and the second reinforcement member are arranged with a space therebetween in a first direction along the second surface. The opening portion is positioned between the first reinforcement member and the second reinforcement member in the first direction.

### BACKGROUND OF THE INVENTION

### Field of the Invention

This disclosure relates to an image forming apparatus, such as a printer, a copier, a facsimile, and a multifunction machine.

### Description of the Related Art

Hitherto, in image forming apparatuses that form an image on a recording material, sometimes, opening portions are formed in doors (open-close portions) that are disposed in an openable and closable manner with respect to an apparatus body. The opening portions serve as windows for visually observing the inside and as ventilation ports for drawing ambient air into the inside of the apparatus body and exhausting internal air to the outside. In an apparatus described in Japanese Patent Laid-Open No. 2015-99374, an opening portion composed of numerous apertures is formed on a side-surface of a door. The air is drawn through this opening portion and is passed through a duct arranged on the back of the door to allow the ambient air to flow into the inside of the apparatus body.

Incidentally, in a case where a wider field of view is required, or larger intake or exhaust volumes is required, it is beneficial to form opening portions with larger opening areas. In the apparatus described in Japanese Patent Laid-Open No. 2015-99374, the opening portion is disposed on the side-surface of the door. Generally, an area of the side-surface of the door is relatively small. Therefore, in conventional technologies, there is an issue that it is difficult to enlarge the areas of the opening portions. In addition, when the opening portions are formed in the doors, the stiffness of the doors decreases, and the doors becomes susceptible to deformation.

### SUMMARY OF THE INVENTION

According to one aspect of the present invention, an image forming apparatus includes an open-close portion including a first surface configured to form part of an exterior and a second surface opposite to the first surface, an opening portion of the open-close portion being provided with at least one through hole penetrating from the first surface to the second surface, a first reinforcement member disposed on the second surface, and a second reinforcement member disposed on the second surface. The first reinforcement member and the second reinforcement member are arranged with a space therebetween in a first direction along the second surface. The opening portion is positioned between the first reinforcement member and the second reinforcement member in the first direction.

Further features of the present invention will become apparent from the following description of exemplary embodiments with reference to the attached drawings.

### BRIEF DESCRIPTION OF THE DRAWINGS

FIG. 1 is a schematic diagram illustrating an inkjet recording apparatus.

FIG. 2 is a cross-sectional view illustrating a cooling module.

FIG. 3 is an enlarged view illustrating a door opening portion of an open-close door.

FIG. 4 is a partially enlarged view illustrating opening holes of the door opening portion.

FIG. 5 is a diagram for explaining a sequence for forming opening holes in odd-numbered rows and even-numbered columns using dies.

FIG. 6 is a diagram for explaining a sequence for forming opening holes in odd-numbered rows and odd-numbered columns using dies.

FIG. 7 is a diagram for explaining a sequence for forming opening holes in even-numbered rows and even-numbered columns using dies.

FIG. 8 is a diagram for explaining a sequence for forming opening holes in even-numbered rows and odd-numbered columns using dies.

FIG. 9A is a perspective view illustrating a back side of the open-close door.

FIG. 9B is an exploded perspective view illustrating the open-close door and reinforcement plates.

FIG. 10 is a cross-sectional view illustrating a reinforcing beam.

### DESCRIPTION OF THE EMBODIMENTS

### Inkjet Recording Apparatus

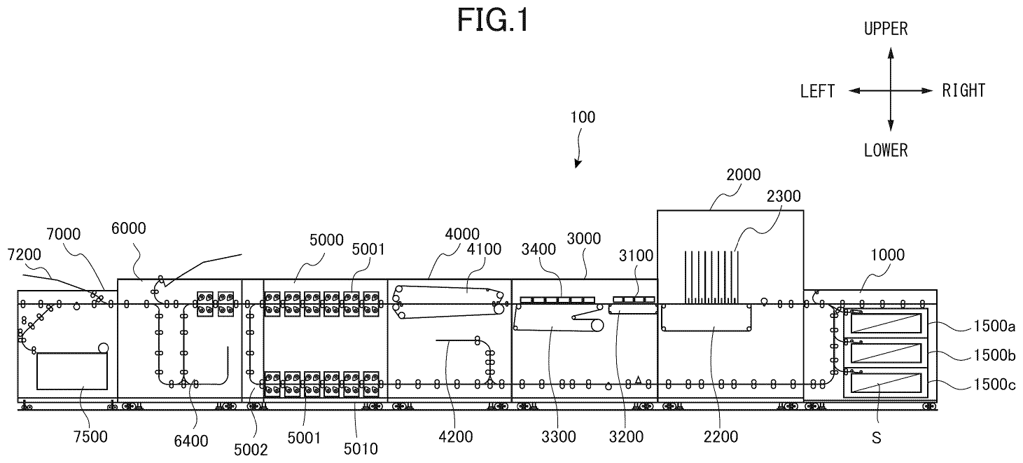

Hereinafter, with reference to drawings, an embodiment of this disclosure will be described. First, using FIG. 1, an inkjet recording apparatus will be described as an example of an image forming apparatus in which is equipped with a door of this embodiment. The inkjet recording apparatus 100 illustrated in FIG. 1 is a so-called sheet-fed inkjet recording apparatus that forms an image on a recording material using ink and a reaction liquid based on image information input from an external device such as a computer and a document reading apparatus. The recording material may be any ink-receptive recording material, for example, paper such as standard paper and thick paper, a plastic film such as a sheet for an overhead projector, a specially shaped sheet such as an envelope and index paper, cloth, and the like.

To be noted, in this specification, a side on which a user stands when operating the inkjet recording apparatus is referred to as a “front side (or front)”, and the opposite side is referred to as a “back side (or back)”. In addition, the left side as viewed from the front side is referred to as the “left”, and the right side as viewed from the front side is referred to as the “right”. FIG. 1 illustrates the inkjet recording apparatus 100 when viewed from the front side. To be noted, some of modules, described below, may not perform processing directly related to the image formation. However, modules 1000 to 7000, described below, form an integrated image formation system as a whole. That is, each of the modules 1000 to 7000 can be regarded as a single image forming apparatus. As a matter of course, the entirety of the modules 1000 to 7000 can be viewed as a single image forming apparatus.

As illustrated in FIG. 1, the inkjet recording system 100 includes a feed module 1000, a print module 2000, a drying module 3000, a fixing module 4000, a cooling module 5000, a reverse module 6000, and a supporting module 7000. The recording material S supplied from the feed module 1000 receives various processing as it is conveyed along conveyance paths within each module, and is finally discharged to the supporting module 7000.

The feed module 1000 includes cassettes 1500a, 1500b, and 1500c that store the recording material S, and each of the cassettes 1500a to 1500c is disposed in a manner drawable toward the front side of the apparatus to store the recording material S. In each of the cassettes 1500a to 1500c, the recording material S is fed one sheet at a time by a separation belt and a conveyance roller and is conveyed to the print module 2000. To be noted, the number of cassettes 1500a to 1500c is not limited to three, and the feed module 1000 may include one or two, or equal to or more than four cassettes.

The print module 2000 includes a pre-imaging conveyance unit (not shown), a print belt unit 2200, and a recording unit 2300. An inclination and position of the recording material S conveyed from the feed module 1000 is corrected by the pre-imaging conveyance unit, and then the recording material S is conveyed to the print belt unit 2200. With respect to the conveyance path of the recording material S, the recording unit 2300 is arranged in a position that faces the print belt unit 2200. The recording unit 2300 ejects the ink from above with respect to the recording material S, which is being conveyed through print belt conveyance, using a plurality of recording heads, and forms the image. By conveying the recording material S via suction with the print belt unit 2200, clearance with the recording heads is ensured. In this embodiment. five line-type recording heads corresponding to four colors: yellow (Y), magenta (M), cyan (C), and black (K), and a head for the reaction liquid are arranged in line along the conveyance direction.

To be noted, the variety of ink colors and the number of the recording heads are not respectively limited to four and five. In addition, to an inkjet method, methods using such as a heating element, a piezoelectric element, an electrostatic element, and a micro electromechanical system (MEMS) element can be adopted. The inks of each color are supplied from ink tanks (not shown) to each of the recording heads through ink tubes.

When the recording material S, on which the image has been formed by the recording unit 2300, is conveyed to an inline scanner (not shown) by the print belt unit 2200, the image formed on the recording material S is detected by the inline scanner (not shown). Here, the misalignment and color density of the image formed on the recording material S are detected, and corrections to the image, density, and the like formed on the recording material S are performed based on this misalignment and color density of the image.

The drying module 3000 includes an ambient air blowing unit 3100, a decoupling unit 3200, a drying belt unit 3300, and a warm air blowing unit 3400. To improve the fixability of the ink on the recording material S by the subsequent fixing module 4000, the drying module 3000 reduces a liquid content of the ink applied to the recording material S.

The recording material S on which the image has been formed is conveyed to the decoupling unit 3200 arranged within the drying module 3000. In the decoupling unit 3200, the wind pressure of air applied from the ambient air blowing unit 3100 arranged above the decoupling unit 3200 produces a friction force between the recording material S and a belt, and the recording material S is conveyed by the belt. In this manner, by conveying the recording material S placed on the belt using the friction force, the misalignment of the recording material S is prevented during conveyance across the print belt unit 2200 and the decoupling unit 3200.

The recording material S conveyed from the decoupling unit 3200 is conveyed via suction on the drying belt unit 3300. The warm air blowing unit 3400 is arranged above the drying belt unit 3300, and blows hot air heated by a heater onto the recording material S that is conveyed from the drying belt unit 3300. Thereby, the ink and reaction liquid applied to the recording material S are dried. In this manner, when the ink and reaction liquid on the recording material S are heated by the drying module 3000, an area of the recording material S to which the ink has been applied becomes less absorbent, and the occurrence of a so-called cockling, where the recording material S locally expands and wrinkles, can be suppressed. As for heaters used to heat the air, heating with, for example, electric resistance wire heaters and infrared heaters is preferable due to safety and energy efficiency considerations. In addition, as drying methods, besides the method of blowing the hot air, methods such as irradiating the surface of the recording material S with electromagnetic waves (such as ultraviolet or infrared rays), or using conductive heat transfer through contact with a heating element may be employed, or, further, these can also be used in combination.

The fixing module 4000 includes a fixing belt unit 4100. The fixing belt unit 4100 fixes the ink on the recording material S by passing the recording material S, which has been conveyed from the drying module 3000, between a heated upper belt unit and a lower belt unit.

The cooling module 5000 includes a plurality of cooling units 5001, and cools the high-temperature recording material S conveyed from the fixing module 4000 using the cooling units 5001. While illustration is omitted, the cooling unit 5001 increases the internal pressure of a cooling box by drawing the air (ambient air) into the cooling box with a fan, and cools the recording material S by directing the air, which is expelled through a nozzle utilizing the pressure, from the cooling box onto the recording material S. With respect to the conveyance path of the recording material S, the cooling units 5001 are arranged on both sides, and cool both sides of the recording material S.

In addition, in the cooling module 5000, a conveyance path switching unit portion is disposed. The conveyance path switching portion 5002 switches the conveyance path of the recording material S depending on whether the sheet S is conveyed to the reverse module 6000 or to duplex conveyance paths for duplex printing to form the image on both sides of the recording material S.

The reverse module 6000 includes a reverse portion 6400. The reverse portion 6400 reverses the front and back of the conveyed recording material S, and changes the front-back orientation of the recording material S upon discharging into the supporting module 7000. The supporting module 7000 includes a top tray 7200 and a supporting unit 7500, and supports the recording material S conveyed from the reverse module 6000.

During the duplex printing, the recording material S is conveyed to a lower conveyance path of the cooling module 5000 by the conveyance path switching portion 5002. Thereafter, the recording material S is returned to the print module 2000 by passing through duplex conveyance paths of the fixing, drying, print, and feed modules 4000, 3000, 2000, and 1000. In a duplex conveyance portion of the fixing module 4000, a reverse unit 4200 that reverses the front and back of the recording material S is disposed. The recording material S, which has been returned to the print module 2000, undergoes the image formation using the ink on the other side, which has not yet undergone the image formation, and is discharged to the supporting module 7000 by passing through the drying module 3000 to the reverse module 6000.

### Open-Close Door

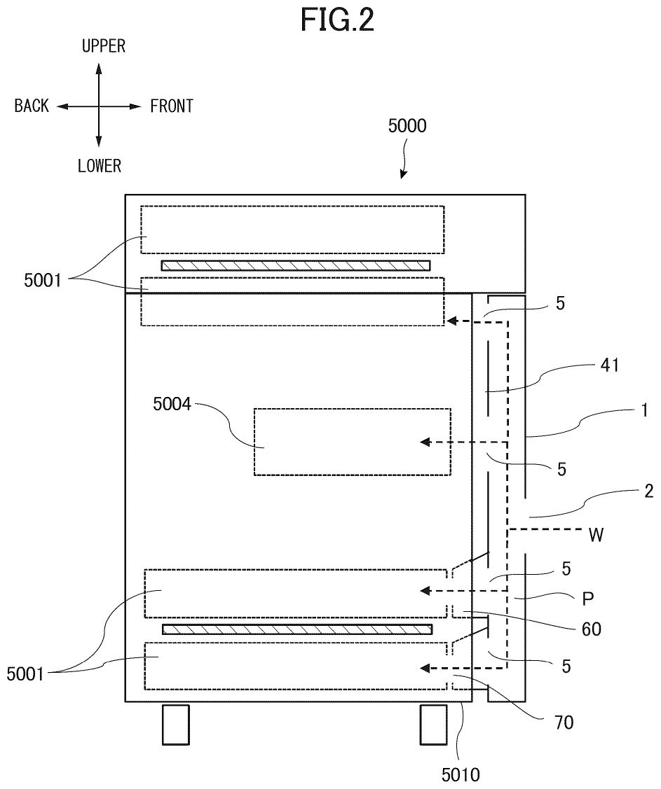

Next, using FIG. 2, an overview of an open-close door 1 of this embodiment will be described. To be noted, in the following description, while the open-close door 1 of this embodiment is applied to the cooling module 5000 as an example, it is not limited to this. For example, the open-close door 1 of this embodiment may also be applied to the other modules such as the print, drying, and fixing modules 2000, 3000, and 4000 that require intake or exhaust ports for air intake and exhaust. In addition, the open-close door 1 does not necessarily need to be equipped with the intake or exhaust ports. For example, also in a case of disposing a window in the open-close door 1 for internal observation, an opening portion is formed in the open-close door 1. Since a transparent cover is provided in typical windows, in this case, the opening portion possesses minimal air permeability. As described above, the embodiment described below is adaptable regardless of the intended application of the opening portion.

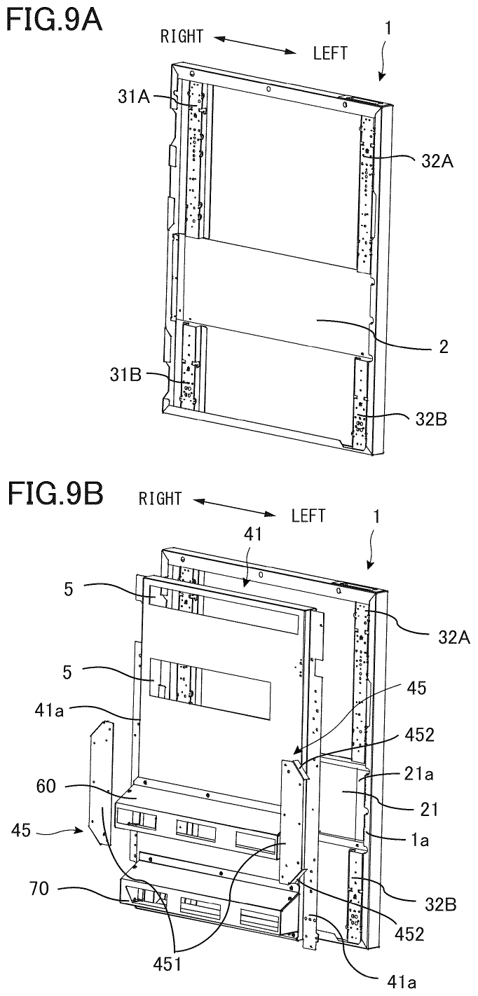

As illustrated in FIG. 2, the open-close door 1, serving as an open-close portion, is disposed on the front side of a frame body 5010 of the cooling module 5000 in an openable and closable manner. A front surface (first surface) of the open-close door 1 forms part of an exterior of the cooling module 5000. Reinforcement plate 41 is arranged on a back surface (second surface) opposite to the front surface of the open-close door 1. By being mounted to reinforcement beams (31A, 31B, 32A, 32B), described below, which are arranged to reinforce the open-close door 1 (refer to FIG. 9A), the reinforcement plate 41 reinforces the open-close door 1 with the reinforcement beams (31A, 31B, 32A, 32B). In addition, the reinforcement plate 41 is arranged with a space from the back surface (second surface) of the open-close door 1 to form a backside duct P.

In the open-close door 1, a door opening portion 2 is formed to penetrate between an inner surface and an outer surface of the open-close door 1. The door opening portion of the open-close door 1 is provided with at least one through hole penetrating formed to penetrate from the front surface to the back surface of the open-close door 1. In this embodiment, as an example, the door opening portion 2 is formed to draw the ambient air from the outside of the frame body 5010 to the inside the frame body 5010. The door opening portion 2 is preferably formed to have a large opening area to ensure adequate airflow through the door opening portion 2. In the case of this embodiment, the door opening portion 2 is formed in a rectangular shape in which a lateral width is larger than a vertical height. In the reinforcement plate 41, a plurality (here, 4) of reinforcement plate opening portions 5, serving as communication ports communicating with a space within the frame body 5010 (inside of the frame body), are formed and arranged in a vertical sequence. The air entering through the door opening portion 2 passes through a space enclosed by the reinforcement beams (31A. 31B, 32A, 32B) and end portion reinforcement plates 45 at both ends (refer to FIG. 9B described below), and is discharged to the inside of the frame body 5010 through the plurality of reinforcement plate opening portions 5 (refer to dotted arrows W). The opening area of each reinforcement plate opening portion 5 is smaller than that of the door opening portion 2 to efficiently discharge the air at a required airflow rate.

In this embodiment, the duct (hereinafter conveniently referred to as the backside duct), which supplies the air drawn from the door opening portion 2 to the cooling units 5001 and a power supply unit 5004 arranged within the frame body 5010), is formed by the open-close door 1, the reinforcement plate 41, the reinforcement beams (31A, 31B, 32A, 32B), and the end portion reinforcement plates 45 (refer to FIG. 9B) on the back of the open-close door 1. To the cooling units 5001, the air that serves to cool the recording material S is supplied, and, to the power supply unit 5004, the air that serves to cool the power supply unit 5004 itself is supplied. In this manner, by forming the backside duct on the open-close door 1, it is possible to secure an airflow path of the drawn air without increasing the size of the apparatus. Then, by forming the door opening portion 2 with a large opening area in the open-close door 1 that is disposed on the front side of the frame body 5010, compared to a case where an opening portion is located on the bottom side, it is possible to avoid a draw-in risk of dust and the like, and it becomes possible to ensure the necessary airflow for the cooling units 5001 and the power supply unit 5004.

In addition, the reinforcement plate 41 is equipped with an upper duct unit 60 and a lower duct unit 70. The upper and lower duct units 60 and 70 direct the air, which is drawn through the door opening portion 2, serving as an intake port, and is supplied from the reinforcement plate openings 5 via the backside duct P, toward a predetermined position in the inside of the frame body 5010. In this embodiment, the upper duct unit 60 is disposed to direct the air toward the cooling units 5001 which are located on an upper side across the conveyance path of the recording material S, and the lower duct unit 70 is disposed to direct the air toward the cooling units 5001 which are located on a lower side across the conveyance path of the recording material S. As illustrated in FIG. 2, the upper and lower duct units 60 and 70 are disposed on the reinforcement plate 41 such that portions of air outlet sides, which expel the air, project into the frame body 5010. In particular, the upper and lower duct units 60 and 70 are arranged such that the respective air outlets are positioned closer to the upper and lower cooling units 5001 so as to ensure the reliable supply of the air drawn through the door opening portion 2.

In a case where the recording material S is blocked within the conveyance path between the upper and lower cooling units 5001 (so-called jam), the recording material S that has jammed in the conveyance path is removed by the user. To remove the recording material S that has jammed in the conveyance path, the user is required to open the conveyance path by opening the open-close door 1 and retracting the upper cooling units 5001 upward with respect to the lower cooling units 5001. As described above, in this embodiment, the upper and lower duct units 60 and 70 are disposed on the backside duct P, which is formed by the open-close door 1, the reinforcement plate 41, and the reinforcement beams (31A, 31B, 32A, 32B), such that the portions of the upper and lower duct units 60 and 70 project into the frame body 5010. Since the upper and lower duct units 60 and 70 are moved in accordance with the backside duct P in synchronization with an opening and closing operation of the open-close door 1, when the open-close door 1 is opened, the upper and lower duct units 60 and 70 are transitioned from a state of projecting into the frame body 5010 to a state of being retracted outside of the frame body 5010. Thereby, in a case where the user opens the open-close door 1, a sufficient space that allows the removal of the recording material S by retracting the upper cooling units 5001 upward is ensured within the frame body 5010.

To be noted, for connecting portions of the upper and lower duct units 60 and 70 with the backside duct P and for connecting portions of the upper and lower duct units 60 and 70 with the cooling units 5001, it is preferable to provide materials such as sponge to prevent air leakage and to suppress loads on the connecting portions during the opening and closing operation of the open-close door 1. To be noted, the backside duct P itself does not require high sealing capability. As long as it is possible to ensure the airflow that enables the adequate supply of the air to the cooling units 5001 and the power supply unit 5004, a gap of a size that does not affect the airflow rate is acceptable.

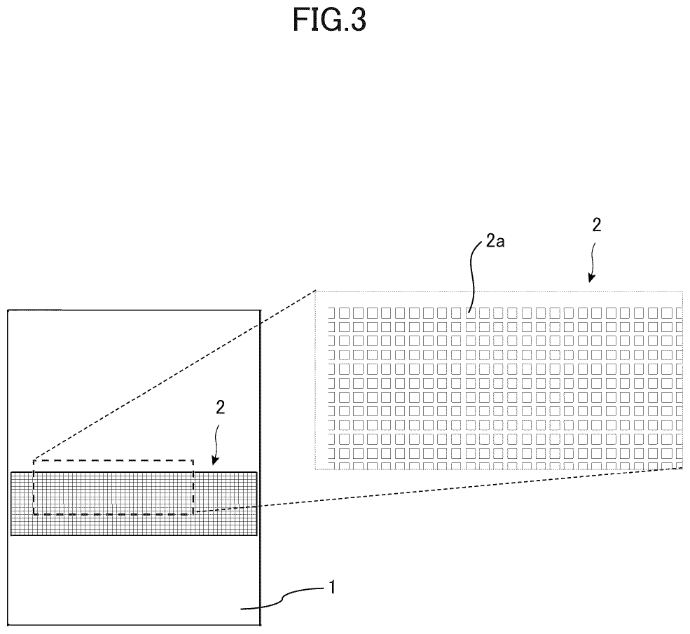

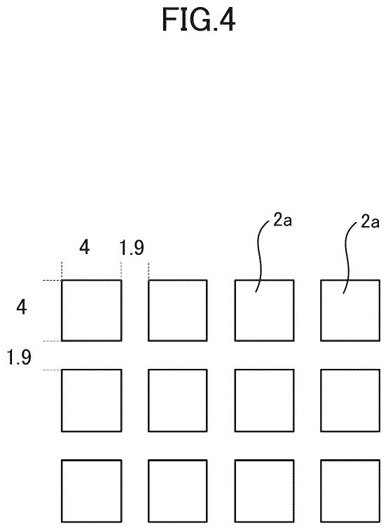

Next, using FIGS. 3 and 4, the door opening portion 2 of the open-close door 1 will be described. FIG. 3 is an enlarged view illustrating the door opening portion 2 of the open-close door 1, and FIG. 4 is an enlarged view illustrating opening holes 2a of the door opening portion 2. As illustrated in FIG. 3, to prevent the entry of foreign substances, the door opening portion 2 is formed in a mesh configuration where numerous opening holes 2a, which are through holes of identical size, are formed. As illustrated in FIG. 4, in this embodiment, the size of the opening holes 2a is, for example, a square with “4 millimeters (mm) in height×4 mm in width”, and spacing between adjacent opening holes 2a is, for example, “1.9 mm”. As illustrated on the left side of FIG. 3, these opening holes 2a are formed to be positioned below the center of the open-close door 1 with respect to the vertical direction and to be aligned in the vertical and lateral directions.

In this embodiment, the length of the door opening portion 2 is longer in the lateral direction than in the vertical direction, and the door opening portion 2 is formed to be as wide as possible in the open-close door 1. The opening area of the door opening portion 2 is determined according to the airflow rate required for supply. To be noted, a formation position of the door opening portion 2 in the vertical direction may be determined based on appearance requirements with exterior covers of the fixing and reverse modules 4000 and 6000 (refer to FIG. 1) connected to the cooling module 5000, and by conditions such as size which limits the likelihood of dust intake.

### Method for Forming Opening Hole

The square shaped opening holes 2a (also called as a square hole) of the door opening portion 2 are formed in the door opening portion 2 using a die in consideration of the manufacturing cost of the open-close door 1. When forming all the opening holes 2a in the door opening portion 2 simultaneously using standard simultaneous punching in press working, spacing between adjacent opening holes 2a is required to be at least three times the thickness of the open-close door 1. However, since, to achieve weight reduction and cost efficiency, a thin sheet, for example, with a thickness of “0.8 mm” is used for the open-close door 1, it is difficult to set the spacing between the adjacent opening holes 2a to “1.9 mm” in a single simultaneous punching operation. Therefore, a method is employed in which a plurality of dies with staggered hole punches are combined, and the opening holes 2a is formed by punching through a plurality of steps, instead of all at once. In a case of using a combination of the plurality of dies with the staggered hole punches for a square hole, described below, by arranging the punches for the square hole in a staggered pattern within each individual die, it becomes possible to form a large number of the opening holes 2a without increasing the spacing between the opening holes 2a to more than three times the sheet thickness of “0.8 mm”. Hereinafter, with reference to FIG. 3, using FIGS. 4 to 8, an example of a method for forming the opening holes 2a will be described.

To form the opening holes 2a in a band-like arrangement as illustrated in FIG. 3, besides a method of using two types of large dies, a method that can be considered involves employing a die with approximately half the size combined with a smaller die. In such a case, dies of different sizes can also be reused for the formation of opening holes in open-close doors that are disposed in modules other than the cooling module 5000 in the openable and closable manner. That is, sometimes, the size of frame bodies may vary depending on the module, and, in such a case, the size of the open-close doors will also change. At this time, creating a dedicated die for each differently sized open-close door to form the opening holes increases costs. Then, by changing combinations of dies with varying sizes, it becomes possible to reuse the dies to form the opening holes, even if the size of the open-close doors varies. Thereby, while the number of steps required to form the opening holes increases, it is possible to achieve a decrease in the manufacturing cost for the open-close doors through reduced die size and a decreased die count.

Whether or not the die can be reused is determined by the combination of evenness and oddness in the number of rows and columns of the opening holes. This is because, in the manufacturing of a single component, the number of required dies varies depending on the number of rows and columns. To be noted, in this embodiment, forming the opening holes by punching components in an opposite direction within the same plane is not anticipated. This is because, since the opening holes form the appearance and, when the component is punched in the opposite direction, a burr direction partially reverses, processes such as surface finishing to improve the appearance become necessary, and the manufacturing cost of the open-close door increases.

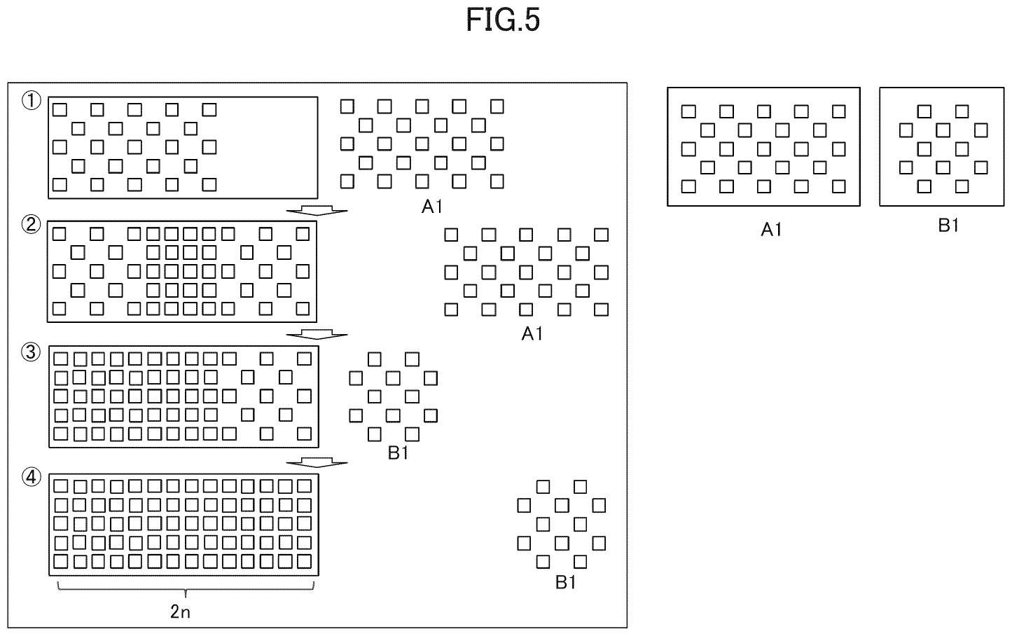

In a case of forming the opening holes in odd-numbered rows with even-numbered columns, a first die A1 and a second die B1 as illustrated on the right side of FIG. 5 are required. A formation process of the opening holes using the first and second dies A1 and B1 is illustrated on the left side of FIG. 5. As illustrated here, the first die A1 is used twice in a shifted state, and, by subsequently using the second die B1 twice on both the left and right sides, the opening portion composed of numerous opening holes is formed.

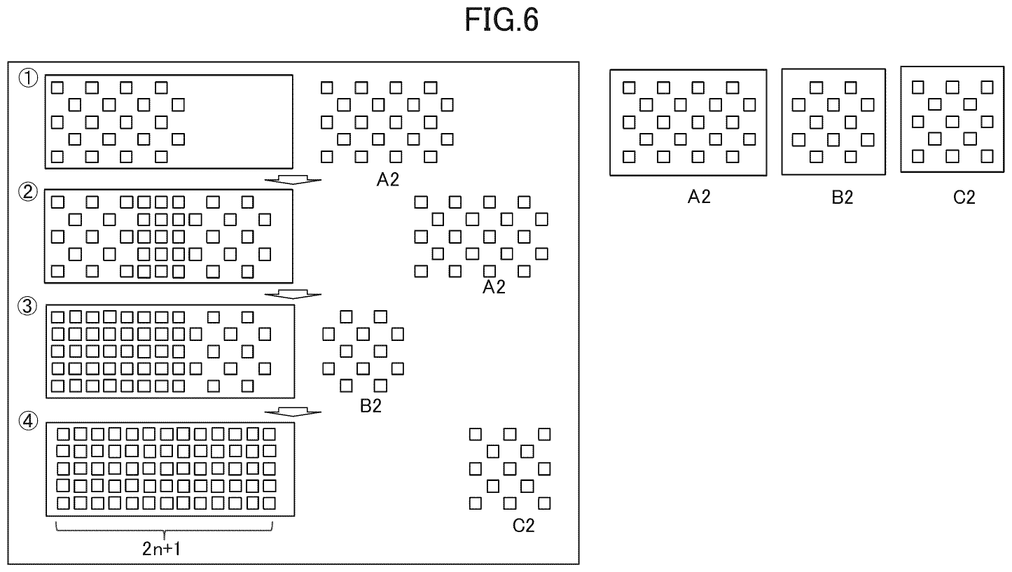

In a case of forming the opening holes in odd-numbered rows with odd-numbered columns, a first die A2, a second die B2, and a third die C2 as illustrated on the right side of FIG. 6 are required. A formation process of the opening holes using the first, second, and third dies A2, B2, and C2 is illustrated on the left side of FIG. 6. As illustrated here, the first die A2 is used twice in the shifted state, and, by subsequently using the second die B2 on the left side and the third die C2 on the right side, the opening portion composed of numerous opening holes is formed.

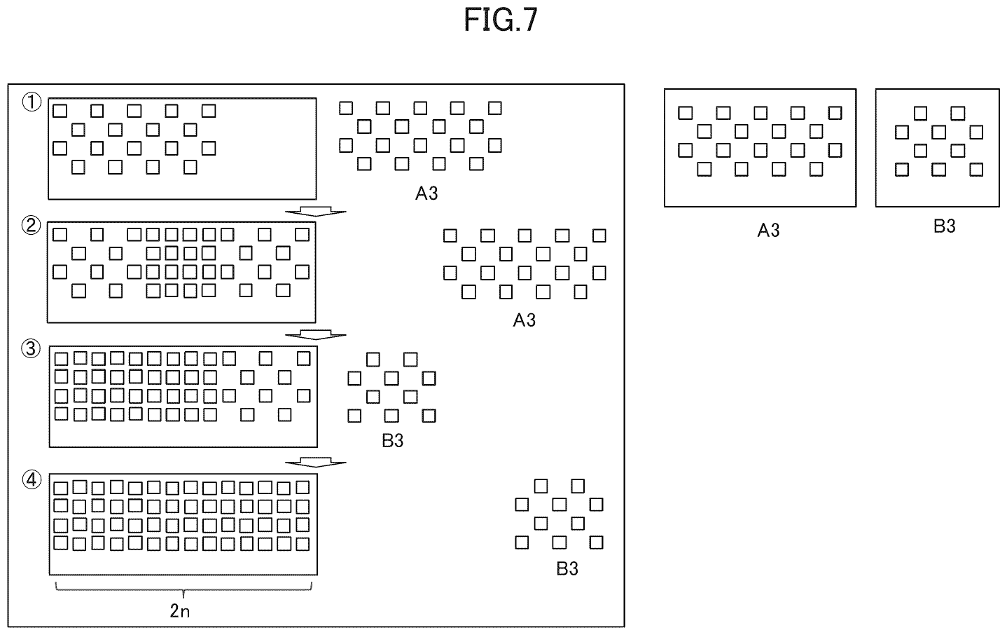

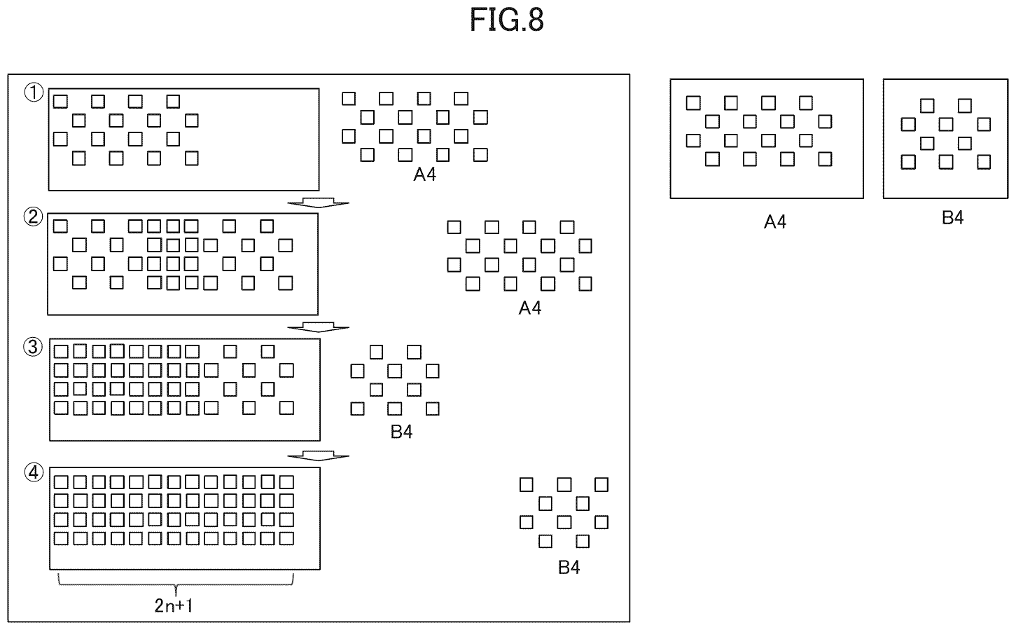

FIG. 7 illustrates a case of forming the opening holes in even-numbered rows with even-numbered columns. In this case, similar to the case of forming the opening holes in odd-numbered rows with even-numbered columns described above (refer to FIG. 5), it is possible to form the opening holes with two types of dies: a first die A3 (same as A1) and a second die B3 (same as B1). FIG. 8 illustrates a case of forming the opening holes in even-numbered rows with odd-numbered columns. In this case, it is possible to form the opening holes with two types of dies: a first die A4 and a second die B4. As illustrated here, the first die A4 is used twice in the shifted state. Subsequently, the second die B4 is used by dividing the application into two stages on each of the left and right sides, with the die rotated 180 degrees at the second stage, and the opening portion composed of numerous opening holes is formed.

Then, in a case of forming the opening holes of two types, which differ in the number of columns, using the method described above, if the opening holes with a column difference in odd numbers on even-numbered rows are to be formed, it is possible to change the number of columns by varying a shift amount of the first die A1. Therefore, the second die B1 used on both ends is changed depending on the number of columns, it is possible to form the opening holes of two types both of which have odd-numbered rows and even-numbered columns but differ in the number of columns with three types of dies. While it is possible to change a shape of the first die A1 by commonly using the second die B1, since, in this case, the second die B1 is smaller than the first die A1, it is more cost efficient to commonly use the larger first die A1 instead of the second die B1.

In a case of forming the opening holes of two types with a column difference in odd numbers on the odd-numbered rows, by reusing the second die B2 and the third die C2 in FIG. 6 and changing the number of columns of the first die, it is possible to form the opening holes of two types both of which have odd-numbered rows and odd-numbered columns but differ in counts of columns with four types of dies while reducing the total number of dies. In a case of forming the opening holes of two types with a column difference between odd and even numbers on the odd-numbered rows, in the formation of odd-numbered columns, the first die A2, which is for the formation of odd-numbered columns, is used as the first die, and, then, it is possible to form the opening holes through the procedure illustrated in FIG. 6. In the formation of even-numbered columns, it is possible to form the opening holes with the first die rotated 180 degrees and shifted. Therefore, it is possible to form the opening holes of two types with a column difference between odd and even numbers on the odd-numbered rows with three types of dies.

In a case of forming the opening holes with a column difference of even numbers on even-numbered rows, similar to the case of the odd-numbered rows, it is possible to form the opening holes of two types with three types of dies. Also, in a case of forming the opening holes with a column difference of odd numbers on even-numbered rows, it is possible to form the opening holes of two types with three types of dies. Lastly, in a case of forming the opening holes with a column difference between odd and even numbers on even-numbered rows, while the first die cannot be used commonly due to a predetermined odd-even pattern, by commonly using the second die, similarly, it is possible to form the opening holes of two types with three types of dies. However, in a case where there is a significant difference in the number of columns, there may be some instances where it is not possible to generate column number combinations by the shift amount of the first die, and, under specific conditions, sometimes, it may be possible to further decrease the number of dies.

In this embodiment, in particular, the number of rows is 28, and counts of columns with different quantities are 113 and 96 columns. Therefore, for example, when the number of columns in the first die is set to 70, to form the opening holes of 113 columns, it is necessary to shift the first die by 43 columns, and, thereby, the second die becomes a die with 43 columns. Subsequently, by employing a 53-column die with a 10-column shift of the die, the opening holes of 96 columns can be formed. As described above, for example, two types of the opening holes with 113 and 96 columns can be formed by using three types of dies with 70, 43, and 53 columns.

### Reinforcement Beam

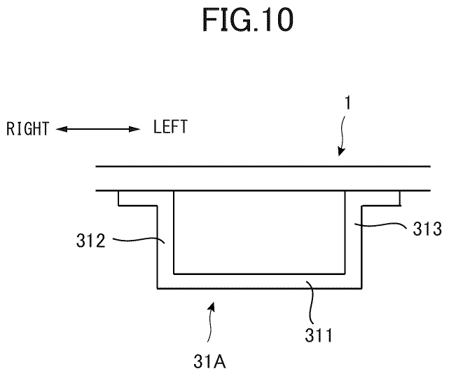

As described above, in this embodiment, the large and wide door opening portion 2 is formed in the open-close door 1 made of the thin sheet. The reinforcement beams 31A, 31B, 32A, and 32B are arranged on the back of this open-close door 1 for reinforcement purposes. Each of the reinforcement beams 31A, 31B, 32A, and 32B is a reinforcement member reinforcing the open-close door 1. The reinforcement plate 41 is secured to the reinforcement beams 31A, 31B, 32A, and 32B with screws or the like to form the backside duct P. With reference to FIG. 2, using FIGS. 9A to 10, the reinforcement beams 31A, 31B, 32A, and 32B will be described.

As illustrated in FIG. 9A, on a right-end side of the back surface of the open-close door 1, the reinforcement beams 31A and 31B, respectively serving as a first reinforcement member and a second reinforcement member, are disposed. On a left-end side of the back surface of the open-close door 1, the reinforcement beams 32A and 32B, respectively serving as a third reinforcement member and a fourth reinforcement member, are disposed. To be noted, since FIGS. 9A to 10 are diagrams illustrating the open-close door 1 from a rearview perspective, the left-right orientation on the diagrams is reversed. The reinforcement beams 31A and 31B are disposed to reinforce the open-close door 1 on a first end side (right-end side) with respect to a longitudinal direction (lateral direction) of the door opening portion 2, and the reinforcement beams 32A and 32B are disposed to reinforce the open-close door 1 on a second end side (left-end side) with respect to the longitudinal direction (lateral direction) of the door opening portion 2. The reinforcement beams 31A and 31B are arranged with a space in the vertical direction (first direction). Then, in the vertical direction, the door opening portion 2 is formed between the reinforcement beams 31A and 31B. In particular, the door opening portion 2 is positioned between the reinforcement beams 31A and 31B in the vertical direction (first direction) when viewed from the lateral direction (second direction), and is arranged to overlap the reinforcement beams 31A and 31B in the lateral direction when viewed from the vertical direction. In other words, when viewed from the vertical direction (first direction), the door opening portion 2 is arranged to at least partially overlap the reinforcing beams 31a and 31B. When viewed in a direction perpendicular to the back surface of the open-close door 1, the reinforcement beams 31A and 31B do not overlap the door opening portion 2. In addition, each of the reinforcement beams 31A and 31B is configured in a shape that extends along the vertical direction. In other words, the reinforcement beams 31A and 31B are a pair of reinforcement beams that extend in a short direction (vertical direction) intersecting with the longitudinal direction of the door opening portion 2. Similarly, the reinforcement beams 32A and 32B are a pair of reinforcement beams that extend in the short direction (vertical direction) of the door opening portion 2. Configuration of the reinforcement beams 32A and 32B, including relative arrangement with respect to the door opening portion 2, is similar to that of the reinforcement beams 31A and 31B. That is, the door opening portion 2 is positioned between the reinforcement beams 32A and 32B in the vertical direction when viewed from the lateral direction (second direction), and is arranged to overlap the reinforcement beams 32A and 32B in the lateral direction when viewed from the vertical direction. In other words, when viewed from the vertical direction (first direction), the door opening portion 2 is arranged to at least partially overlap the reinforcement beams 32a and 32B.

The reinforcement beams 31A and 31B are arranged with the space, and, with a configuration in which the door opening portion 2 is formed between the reinforcement beams 31A and 31B, it is possible to easily increase an area of the door opening portion 2. This is because, if single reinforcement beams are arranged on each of the right-end side and left-end side of the back surface of the open-close door 1 to overlap the door opening portion 2, the opening area of the door opening portion 2 will be reduced by these reinforcement beams. In addition, if the reinforcement beams overlap the door opening portion 2, the reinforcement beams will be visible from the door opening portion 2 when the open-close door 1 is viewed from the front, which decreases appearance quality. Therefore, in this embodiment, the reinforcement beams are arranged to reinforce the open-close door 1 with the configuration in which the reinforcement beams are divided into the reinforcement beams 31A and 31B across the door opening portion 2 on the right-end side and into the reinforcement beams 32A and 32B across the door opening portion 2 on the left-end side. Since these reinforcement beams 31A, 31B, 32A, and 32B do not overlap the door opening portion 2, the opening area of the door opening portion 2 is not reduced. Therefore, the airflow through the door opening portion 2 of the open-close door 1 is not obstructed, and it is possible to ensure the sufficient airflow rate. In addition, since, when the open-close door 1 is viewed from the front, the reinforcement beams 31A, 31B, 32A, and 32B are not visible from the door opening portion 2, there is not a risk of decreasing the appearance quality. To be noted, when part of the reinforcement beam 31A or 31B overlaps the door opening portion 2, the opening area is reduced proportionally. However, even in such a case, since the reinforcement beams 31A and 31B are arranged with the space, in that respect, it is possible to obtain an adequate opening area.

Each of the reinforcement beams 31A, 31B, 32A, and 32B is formed into a cross-sectionally projecting shape with a projecting portion directed backward (in other words, toward the frame body 5010 in a state in which the open-close door 1 is closed). The reinforcement beam 31A will be described as a representative. FIG. 10 illustrates a cross-sectional view of the reinforcement beam 31A taken along a plane that extends along the back surface of the open-close door 1 and includes the second direction (lateral direction) intersecting with the vertical direction and the direction perpendicular to the back surface of the open-close door 1. As illustrated in FIG. 10, each of the reinforcement beams 31A, 31B, 32A, and 32B includes a first sheet metal portion 311, a second sheet metal portion 312, and a third sheet metal portion 313. The first sheet metal portion 311 faces the back surface of the open-close door 1 with a space and extends in the vertical direction (first direction). The first sheet metal portion 311 includes a right-end (first end) and a left-end (second end) opposite to the first end in the second direction (lateral direction), and the second sheet metal portion 312 is formed through a bending process from the right-end of the first sheet metal portion 311 toward the back surface of the open-close door 1. Similarly, the third sheet metal portion 313 is formed through a bending process from the left-end of the first sheet metal portion 311 toward the back surface of the open-close door 1.

As illustrated in FIG. 9B, by securing the reinforcement plate 41 to the projection portions of the reinforcement beams 31A, 31B, 32A, and 32B, the backside duct P described above is formed. Both lateral end portions of the reinforcement plate 41 are initially bent once toward the front, and then tips of both end portions are further bent toward the exterior of the open-close door 1. Thereby, mounting portions 41a for securing to the projection portions described above are formed over the whole length of the reinforcement plate 41 in the vertical direction. Therefore, by changing the height of the projection portions of the reinforcement beams 31A, 31B, 32A, and 32B, it is possible to adjust the space between the back surface of the open-close door 1 and the reinforcement plate 41 to match the required airflow rate.

In the door opening portion 2 of the open-close door 1, a louver component 21 including airflow rectifying blades (known as louvers) for rectifying airflow is mounted to cover the door opening portion 2 from the back side. Both lateral end portions of the louver component 21 are bent once toward the back, and then tips of both bent end portions are further bent toward the center of the open-close door 1. Thereby, the mounting portions 21a that can be secured to the reinforcement plate 41 are formed to extend over the whole length of the louver component 21 in the vertical direction. In this manner, both the lateral end portions of the louver component 21 are bent twice to form the mounting portions 21a which can be secured to the reinforcement plate 41, and the mounting portions 21a of the louver component 21 are secured to the reinforcement plate 41. Thereby, the louver component 21 complements the reinforcement of the open-close door 1 by suppressing a decrease in the stiffness of the reinforcement beams themselves due to the distributed arrangement of the reinforcement beams 31A, 31B, 32A, and 32B.

In addition, on both the end portions of the door opening portion 2, the end portion reinforcement plates 45 at both ends are disposed to secure the reinforcement plate 41 to the reinforcement beams 31A, 31B, 32A, and 32B and the louver component 21. Each of the end portion reinforcement plates 45 is arranged to extend between the reinforcement beams 31A and 31B, which are arranged in the vertically divided configuration, and between the reinforcement beams 32A and 32B, which are also arranged in the vertically divided configuration. Each of the end portion reinforcement plates 45 include a plate portion 451 that overlaps and is connected to each of the first sheet metal portion 311 of the upper reinforcing beam 31A (32A) and the first sheet metal portion 311 of the lower reinforcement beam 31B (32B) (refer to FIG. 10), and a bent portion 452 formed by a bending process from the plate portion 451 toward the back surface (second surface) of the open-close door 1. Each of the end portion reinforcement plates 45 is individually secured to the reinforcement beams 31A and 31B and the louver component 21, and to the reinforcement beams 32A and 32B and the louver component 21 with screws or the like. That is, one side of the end portion reinforcement plates 45 is a first connecting portion connecting the reinforcement beams 31A and 31B, and the other side of the end portion reinforcement plates 45 is a second connecting portion connecting the reinforcement beams 32A and 32B. The end portion reinforcement plates 45 are mounted such that the respective bent portions 452 seal gaps of the open-close door 1 with the reinforcement plate 41 and the reinforcement beams 31A and 31B, and gaps of the open-close door 1 with the reinforcement plate 41 and the reinforcement beams 32A and 32B. Thereby, air leakage from the backside duct P through the gaps is suppressed by the bent portions 452.

The reinforcement plate 41 is secured to the louver component 21 such that the mounting portions 41a are sandwiched between the mounting portions 21a of the louver component 21 and the end portion reinforcement plates 45. In addition, the end portion reinforcement plates 45 are also secured to mounting portions 1a, which are formed by twice bending both the end portions of the open-close door 1, with screws or the like. As described above, by disposing the end portion reinforcement plates 45 between the reinforcement beams 31A and 31B, which are arranged in the vertically divided configuration, and between the reinforcement beams 32A and 32B, which are also arranged in the vertically divided configuration, the decrease in the stiffness of the reinforcement beams themselves due to the distributed arrangement of the reinforcement beams 31A. 31B, 32A, and 32B is suppressed, and the reinforcement of the open-close door 1 is complemented.

As described above, in this embodiment, in the thin sheet open-close door 1 in which the large and wide door opening portion 2 is formed, the reinforcement beams 31A, 31B, 32A, and 32B are arranged on the back for reinforcement purposes. However, in the case of this embodiment, the reinforcement beams 31A and 31B are arranged in the divided configuration across the door opening portion 2 at the positions not overlapping the door opening portion 2, and the reinforcement beams 32A and 32B are similarly arranged in the divided configuration across the door opening portion 2 at the positions not overlapping the door opening portion 2. Since these reinforcement beams 31A, 31B, 32A, and 32A do not overlap the door opening portion 2, the opening area of the door opening portion 2 is not reduced, and the reinforcement beams are not visible from the door opening portion 2 when the open-close door 1 is viewed from the front. Therefore, it is possible to maintain the wide opening area of the door opening portion 2 without reduction while maintaining the appearance quality of the open-close door 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-061632, filed Apr. 5, 2024, which is hereby incorporated by reference herein in its entirety.

What is claimed is:

1. An image forming apparatus comprising:
an open-close portion including a first surface configured to form part of an exterior and a second surface opposite to the first surface, an opening portion of the open-close portion being provided with at least one through hole penetrating from the first surface to the second surface;
a first reinforcement member disposed on the second surface; and
a second reinforcement member disposed on the second surface,
wherein the first reinforcement member and the second reinforcement member are arranged with a space therebetween in a first direction along the second surface, and
wherein the opening portion is positioned between the first reinforcement member and the second reinforcement member in the first direction.

2. The image forming apparatus according to claim 1, further comprising:
a first connecting portion that extends in the first direction between the first reinforcement member and the second reinforcement member and is connected to each of the first reinforcement member and the second reinforcement member.

3. The image forming apparatus according to claim 2, further comprising:
a duct that communicates with the through hole provided in the opening portion and is configured to form an airflow path from or to the through hole,
wherein the first connecting portion is configured to form a part of the duct.

4. The image forming apparatus according to claim 2, wherein
when viewed from a direction perpendicular to the second surface, the first reinforcement member does not overlap the opening portion,
when viewed from the direction perpendicular to the second surface, the second reinforcement member does not overlap the opening portion, and
when viewed from the direction perpendicular to the second surface, the first connecting portion overlaps the opening portion.

5. The image forming apparatus according to claim 1, wherein
each of the first reinforcement member and the second reinforcement member includes:
a first sheet metal portion that faces the second surface with a space, extends in the first direction, and includes a first end and a second end opposite to the first end in a second direction along the second surface and intersecting with the first direction;
a second sheet metal portion that is formed by bending from the first end of the first sheet metal portion toward the second surface; and
a third sheet metal portion that is formed by bending from the second end of the first sheet metal portion toward the second surface.

6. The image forming apparatus according to claim 5, further comprising:
a duct that communicates with the through hole and is configured to form an airflow path from or to the through hole,
wherein the duct further includes a first connecting portion that extends in the first direction between the first reinforcement member and the second reinforcement member and is connected to each of the first reinforcement member and the second reinforcement member, and
wherein the first connecting portion includes:
a plate-shaped portion that is overlapped with and connected to each of the first sheet metal portion of the first reinforcement member and the first sheet metal portion of the second reinforcement member, and
a bent portion that is formed by bending from the plate-shaped portion toward the second surface.

7. The image forming apparatus according to claim 1, wherein
each of the first reinforcement member and the second reinforcement member extends in the first direction and are aligned in the first direction.

8. The image forming apparatus according to claim 1, further comprising:
a third reinforcement member disposed on the second surface; and
a fourth reinforcement member disposed on the second surface,
wherein the third reinforcement member and the fourth reinforcement member are arranged with a space therebetween in the first direction,
wherein a longitudinal direction of the opening portion is aligned with a second direction that is along the second surface and intersects with the first direction,
wherein the opening portion is positioned between the third reinforcement member and the fourth reinforcement member in the first direction,
wherein the first reinforcement member and the second reinforcement member are arranged on a first end side of the opening portion in the second direction, and
wherein the third reinforcement member and the fourth reinforcement member are arranged on a second end side opposite to the first end side of the opening portion in the second direction.

9. The image forming apparatus according to claim 8, further comprising:
a reinforcement plate that extends between the first reinforcement member and the third reinforcement member and between the second reinforcement member and the fourth reinforcement member.

10. The image forming apparatus according to claim 9, wherein
a communication port that is configured to pass air that is either drawn or exhausted through the through hole in the opening portion is formed in the reinforcement plate.

11. The image forming apparatus according to claim 10, further comprising:
a duct that communicates from the through hole in the opening portion to the communication port,
wherein the duct includes:
the reinforcement plate;
a first connecting portion that extends in the first direction between the first reinforcement member and the second reinforcement member and is connected to each of the first reinforcement member and the second reinforcement member; and
a second connecting portion that extends in the first direction between the third reinforcement member and the fourth reinforcement member and is connected to each of the third reinforcement member and the fourth reinforcement member.

12. The image forming apparatus according to claim 9, wherein
each of the first to fourth reinforcement members includes:
a first sheet metal portion that faces the second surface with a space, extends in the first direction, and includes a first end and a second end opposite to the first end in the second direction;
a second sheet metal portion that is formed by bending from the first end of the first sheet metal portion toward the second surface; and
a third sheet metal portion that is formed by bending from the second end of the first sheet metal portion toward the second surface, and
the reinforcement plate is connected to each of the first sheet metal portions of the first to fourth reinforcement members.

13. The image forming apparatus according to claim 1, further comprising:
a duct that communicates with the through hole in the opening portion and forms an airflow path from or to the through hole,
wherein the duct is attached to the open-close portion so as to move in accordance with an opening and closing operation of the open-close portion.

14. The image forming apparatus according to claim 1, wherein
a plurality of the through holes are provided in the opening portion.
